(19) United States
(12) Patent Application Publication
(10) Pub. No.: US 2002/0175917 A1
(43) Pub. Date: Nov. 28, 2002

(54) Method and system for streaming media manager

(76) Inventors: Dipto Chakravarty, Gaithersburg, MD (US); Jack Tam, Gaithersburg, MD (US); Maryam Norouzi, Rockville, MD (US); An Hoang, Clarksburg, MD (US); Jordan Xu, Randallstown, MD (US); Liu Yang, North Potomac, MD (US)

Correspondence Address: Cynthia K. Nicholson, Esquie, Hale and Dorr LLP, 1455 Pennsylvania Avenue, N.W., Washington, DC, 20004, US

(21) Appl. No.: 09/828,868

(22) Filed: Apr. 10, 2001

(51) Int. Cl. G06T 15/40; G06T 15/10; G06T 15/20; G06T 13/00; G06T 15/70; G09G 5/00

(52) U.S. Cl. 345/473; 345/723; 345/475; 345/427; 345/421

(57) ABSTRACT

A computer-implemented or computer-enabled method and system is provided for working with streaming media, such as digital video clips and entire videos. Clips can be grouped together and snippets of video can be re-ordered into a rough cut assemblage of a video storyboard. Later, the video storyboard and the final video scene may be fine-tuned. The invention is not limited to digital video, and may also be used with other digital assets, including for example audio, animation, logos, text, etc.

Accordingly, computer-enabled storyboarding of digital assets includes providing a storage having digital assets, the digital assets including at least one digital clip, and each digital clip having frames including a key frame corresponding to the digital clip. Digital clips are selected to be included in a storyboard. The storyboard is displayed, including an image for the key frame corresponding to each of the digital clips of the storyboard. Preferably, the image is a low-resolution image representing the key frame for the digital clips. The storyboard may be modified and saved, including adding parts of digital assets to the storyboard, deleting digital clips from the storyboard, and re-ordering the order of the clips in the storyboard. The digital clips can be edited/adjusted, including adjusted the in and/or out time of each clip. The storyboard may be played, that is each digital clip in the storyboard is played in sequence.

### BACKGROUND OF THE INVENTION

1. Field of the Invention

The present invention concerns methods for managing streaming media. More particularly, it concerns computer-implemented or computer-enabled methods for creating, viewing, saving and editing, or storyboarding digital assets. Digital assets that may be storyboarded include, by way of example, digital video, digital audio, etc.

2. Related Art

Video and other forms of animation traditionally have been manually laid out on storyboards to set out the timing of events for scenes in the video. Ordinarily, for any scene, much more film is shot than is used for a final film clip for that scene. The film traditionally is manually cut and spliced by a film editor, who then pastes together the desired shots. The storyboard is created by hand and represents the plan of the film video or scene that is to be created by the film editor.

The media and entertainment industry have an analogous method known as an edit decision list or “EDL”. In a photo shoot for a movie, several cameras cover each scene. Ultimately, the editor utilized the EDL to decide which camera will be used for each particular period of time, and then edits the physical film footage to obtain a final product for a scene. The EDL is useful in the analog world of 16 millimeter camera shoots.

FIG. 13 illustrates a prior art digital storyboard. In this particular example, the storyboard includes cells and columns representing the clips. The storyboard is changed by performing actions on the cells and columns, after which the storyboard is reevaluated. The storyboard of FIG. 13 is shown in U.S. Pat. No. 5,604,857. In the first column, Clips A, B and C (the first column) may represent the animated company logo and title. In the next column, Clip D may represent the text describing the products use in one country, while Clip G may represent the text describing the products use in another country. Clip E represents the graphic of the product itself, while Clips F and H represent the graphical map of the two countries.

FIG. 12 is one example of an off-line, digital video editing computer system 1210, including a digital editor 1212 for editing digitized versions of video or digitized video version of film. The system of FIG. 12 is shown in U.S. Pat. No. 6,016,380. The system provides digital editing capabilities for editing a video version 1214 of the source film 1216, and provides digital editing capabilities for editing a source video 1218. This system provides user input/output via a display 1219 that includes graphical user interface and other suitable components. As a source video is edited, a digital editor 1212 keeps an account of each edit event and synchronization point for the event. The set of edit events comprise an edit event sequence 1220, which the digital editor works on for an editing user. The edit list manager 1222 processes the edit sequence 1220 to provide a record of the edit events. In this example, there are two types of edit event records: a film cut list 1224, used to directly manipulate a source film 1216; and a edit decision list 1226, used to produce an edited version of a source video including the edits created by the editing system. The EDL is particularly useful for creating the so called “rough cut”, which provides the ability to view the edited film without physically producing the edits.

FIG. 1 is an illustration of a digital version of a video, or a collection of clips. A digital video 101 is comprised of a collection of clips 103. Each clip 103 is further comprised of a group 105 having several consecutive frames 109, beginning with the first frame of the clip 107. Typically, the first frame of the clip is distinguished by being discontinuous with the previous frame. Different methods are known in the art for dividing a digital video into a series of clips including simply slicing by arbitrary time periods.

The use of the EDL, as mentioned previously, works very well in the analog world of 16 millimeter camera shoots. However, the EDL is not particularly appropriate for use with digital assets. Among other things, the use of digital assets presents a number of hurdles, including that digital assets cannot be physically handled, unlike film, and that digital assets must be electronically managed. Nevertheless, digital assets, if managed appropriately, can be highly reliable and efficient.

### SUMMARY OF THE INVENTION

According to the invention, there is provided a computer-implemented or computer-enabled method and system for working with digital video clips and entire videos. Clips can be grouped together and snippets of video can be re-ordered into a rough cut assemblage of a video storyboard. Later, the video storyboard and the final video scene may be fine-tuned. The invention is not limited to digital video, and may also be used with other digital assets, including for example audio, animation, logos, text, etc.

In accordance with the invention, there is provided a method and system for computer-enabled storyboarding of digital assets. It includes providing a storage having digital assets, wherein at least a portion of the digital assets are digital stream, each of the digital assets including at least one digital clip, each digital clip having frames including one key frame corresponding to the digital clip. It further includes selecting, from the digital assets, digital clips to be a storyboard. It also includes transmitting, to a computer screen, an electronic signal representing a display corresponding to the storyboard, the display presenting an image for the key frame corresponding to each of the digital clips of the storyboard; wherein the image is a low-resolution image representing the key frame for at least one of the digital clips; wherein the image further includes (i) a title associated with the at least one digital clip, (ii) and a timing of the at least one digital clip. Also included is modifying the storyboard, including (i) adding, responsive to a user add request, at least a portion of another digital asset, to the storyboard; (ii) deleting, responsive to a user delete request, one of the digital clips from the storyboard; (iii) re-ordering, responsive to a user re-order request, an order of the digital clips in the storyboard; and (iv) storing, responsive to a user save request, the storyboard. Also included is modifying at least one of the digital clips in the storyboard, including (i) adjusting, responsive to a user request, a beginning time for at least one of the digital clips; (ii) adjusting, responsive to a user request, an end time for at least one of the digital clips; and (iii) storing, responsive to the user request, the adjusted time for at least one of the digital clips. Further included is playing the storyboard, including playing each digital clip in the storyboard in sequence.

According to one optional aspect of the invention, the storyboard is designated as private access or public access.

According to a further optional aspect of the invention, there are several storyboards, each storyboard including a variety of different digital clips.

In accordance with yet another option, responsive to a preview request, a list of storyboards is presented, and further responsive to a selection request, one of the storyboards is selected, and further responsive to a selection request of at least one digital clip in the storyboard, the at least one digital clip is played. Playing the digital clip optionally includes determining a type of the digital clip, launching a player corresponding to the type of the digital clip, and running the player for the digital clip.

In accordance with another optional aspect of the invention, the storyboard is stored as a derivative digital asset.

The digital assets may be, for example, digital video, animation, still shot, text, and/or audio.

In accordance with a further preferred aspect of the invention, the storyboard is saved in storage as an ordered set of the plurality of digital clips, representing the storyboard. Optionally, responsive to a request to remove a selected one of the storyboards, the ordered set representing the selected one of the storyboards is deleted.

Further, according to one optional aspect of the invention, a clip name is associated with the storyboard.

In accordance with another optional aspect of the invention, a caption is stored for the key frame for at least one of the digital clips, wherein the display corresponding to the storyboard includes the caption for the key frame.

In accordance with yet another optional aspect, the invention includes storing each of the digital clips, each of the corresponding key frames, and data concerning a correspondence between the digital clip and the corresponding key frame. Preferably, there is a lightweight image for the corresponding key frame for the at least one digital clip, and the lightweight image is stored. The storage for the lightweight image may be a database; and the storage for the digital clips and the key frames may include a streaming video server data store.

Optionally, the invention provides for the exporting of digital clips in the storyboard in an export stage. Further optionally, the invention provides for the importing of at least one of the digital assets. Importing may include importing a digitally encoded video file as at least one of the digital asset; and/or importing a resource located at a URL as at least one of the digital assets.

A further option includes accessing at least one of the selected digital clips from the database, including retrieving a corresponding meta file from the database, and retrieving a corresponding digital stream from the streaming video server data store.

According to a further optional aspect of the invention, importing at least one of the digital assets may include (i) if the at least one digital asset is analogous to video, and if the at least one digital asset is digital video, then ingesting the at least one digital asset via a regular import; (ii) otherwise, if the at least one digital asset is analogous to video and if the at least one digital asset is analog video, then encoding the at least one digital asset; and if a chunk is requested, then (a) inputting the at least one digital asset to a video logger to create a plurality of digital clips; otherwise (b) utilizing the at least one digital asset as one of the plurality of digital clips.

According to another optional aspect of the invention, properties are associated with at least a portion of the plurality of digital assets, and the properties associated with at least one digital asset of the digital assets may be exported. In accordance with another optional aspect of the invention, properties are associated with at least a portion of the digital assets, and exporting may include (i) at least one digital asset of the plurality of assets, and (ii) the plurality of properties associated with the at least one digital asset.

These and other objects, features and advantages of the present invention are readily apparent from the following drawings and detailed description of the preferred embodiments.

### BRIEF DESCRIPTION OF THE DRAWINGS

The preferred embodiments of the invention are described in detail in connection with the drawings, in which:

FIG. 1 is a block diagram of a prior art digital video clip.

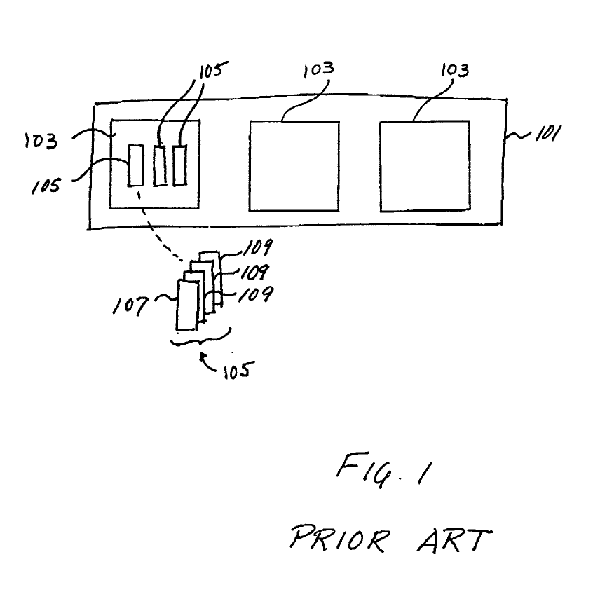

FIG. 2 is an example display of a collection of digital videos.

FIG. 3 is an example display for saving a created digital video set.

FIG. 4 is an exemplary display of a series of key frames of a parent video.

FIG. 5 is a block diagram illustrating the data flow for digital video clips.

FIG. 6 is a block diagram illustrating data flow of pre-digitized video.

FIG. 7 is a block diagram illustrating data flow of a clip identifier in a digitized video.

FIG. 8 is a block diagram illustrating an ordered set of clips.

FIG. 9 is a block diagram illustrating a clip identifier in a video storyboard and a new asset.

FIG. 10 is a block diagram illustrating a clip time adjuster.

FIG. 11 is a block diagram illustrating an example creation of a particular video storyboard.

FIG. 12 is a block diagram of a prior art edit list management system.

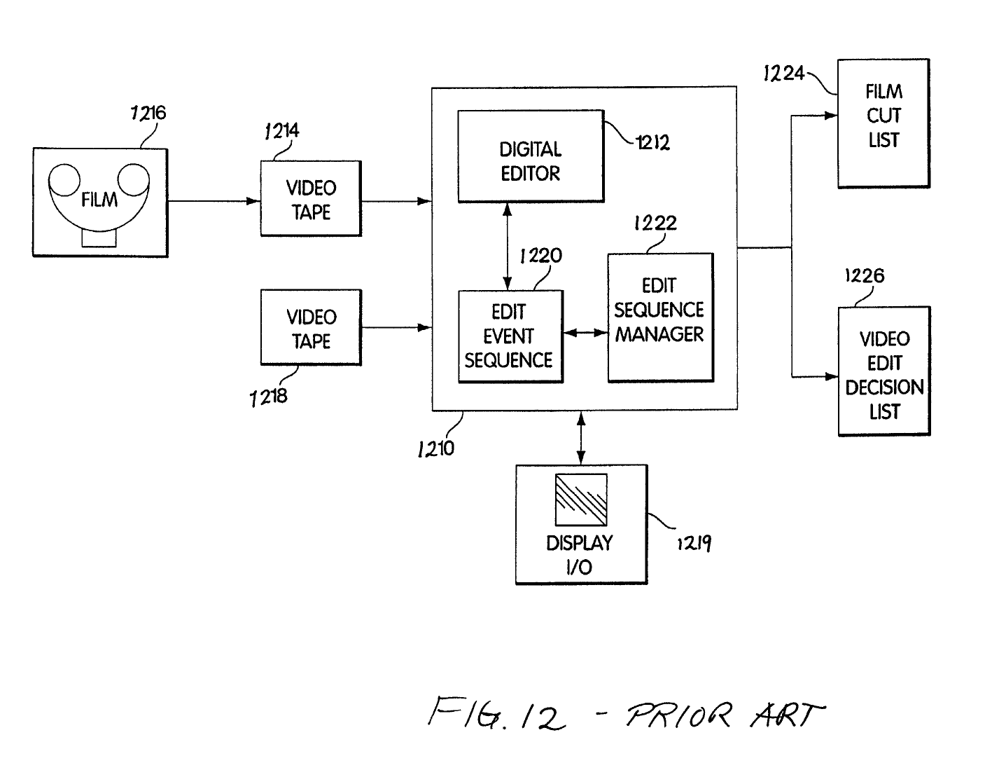

FIG. 13 is an example of a prior art video storyboard.

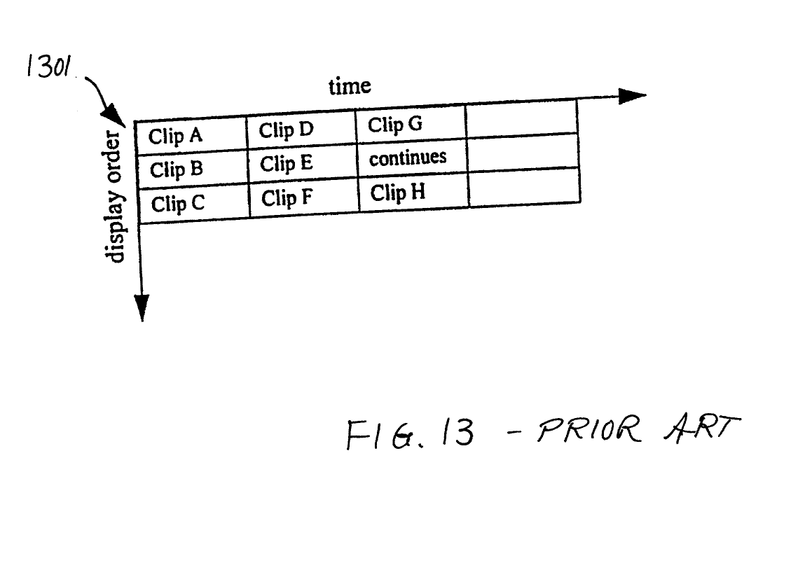

FIG. 14 is an illustration showing the relation of video to key frames to a clip.

### DETAILED DESCRIPTION OF THE PREFERRED EMBODIDEMENTS

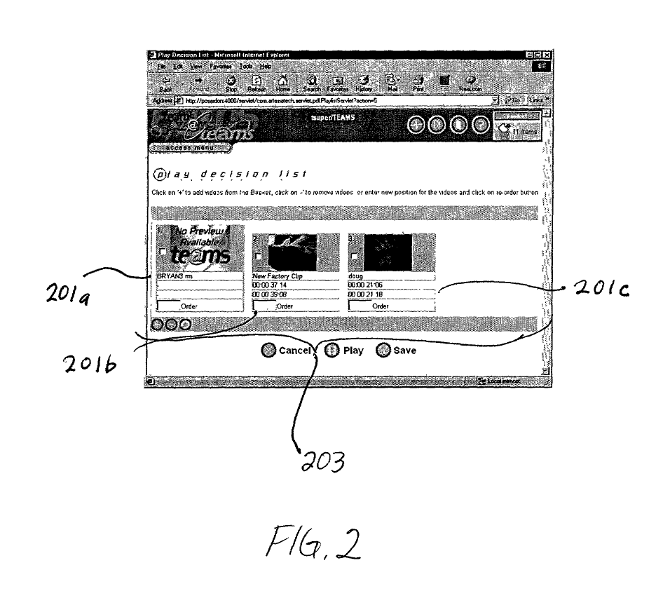

The invention is described in connection with FIGS. 2 through 11 and 14.

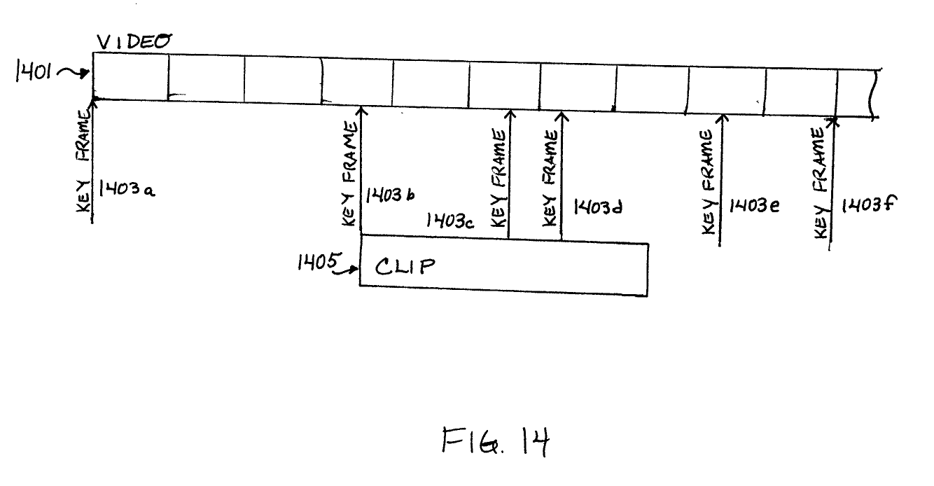

Some of the taxonomy used in the following description is illustrated in FIG. 14, showing a relation of a digital video to key frames to a clip. A digital video 1401 comprises a series of digital pictures, which may or may not be related, as generated typically by an encoder. The video includes a series of frames, and is viewed over time. Some of these frames within the video 1401 are selected as key frames 1403a-f. A key frame is typically selected by a user as indicating the beginning of a cohesive sequence of pictures. Key frames may be selected automatically or arbitrarily, as well. Each key frame thus is a snapshot representative of its sequence. Key frames may be used as a navigational aid for examining and traversing the video, to select or lasso or bracket a particular section or sections of the video, and for editing the section(s) of the video, to ultimately be used in a clip 1405. The term clip is used to refer to a selected portion or portions of the video, whether or not that portion has been edited. Clips may be combined and further edited, resulting in another clip. A clip may be created from more than one digital video, if desired.

Consider that there is provided a collection of digital assets or digital videos, in no particular order. At an initial stage, these digital assets would be collected together, which can be loosely referred to as a “collection” or a basket. From this collection of digital assets, one can select and edit a particular order of videos, to the end of “storyboarding” a digital video clip.

Reference is made to FIG. 2. As illustrated in this particular example, there are provided from a collection of digital assets, several digital videos 201A, 201B, 201C. The digital videos 201A-C may be of any length, or may be clips. The combination of digital videos and/or clips which are being worked on is a “storyboard” 203. The user interface advantageously represents each digital video or clip 201A, 201B, 201C by displaying a key frame, or preferably by displaying a thumbnail representation of the key frame. Preferably, the system also displays any title associated with the clip or video, and the start time and end time of the video or clip. As illustrated, the start time and end time may reflect the clip's timing relative to the digital video. In preferred embodiments, any one of these digital videos or clips may be selected by the user and run on any appropriate video player, so that the viewer may review the selected digital video.

In the preferred embodiment, digital videos may be added to or removed from the storyboard 203. As is shown, there is provided a button to click in order to select a video from the basket. Another button is provided in order to delete a video from the storyboard. Also, as illustrated, a user may indicate the ordering of each clip or video in the storyboard, e.g., 1, 2, 3, etc.; a button is provided to re-order the clips in the specified order. The videos in the storyboard may be placed in a desired order in alternative ways. For example, a user may click and drag the displayed thumbnail to another location in the storyboard. One of skill in the art will appreciate that there are other ways in which to add elements from a set to a subset, and to add, delete, or re-order displayed items.

The storyboard is, in effect, an ordered set. The ordered set of digital videos may itself be saved as a digital asset. That is, in highly preferred embodiments, the system stores references to members of the set, and the order of the members of the set. Here, the members of the set could constitute the clips and/or the videos included in the storyboard. Further, the system could store information relating to the beginning and end of the clips which are in the storyboard. This information could be stored in a number of ways, including strictly by example, as a pointer to the clip, or an offset from the start of the video (for the beginning of the clip); and as a pointer to the end of the clip, an offset from the start of the clip, or an offset from the start of the video (for the end of the clip).

In highly preferred embodiments, the storyboard may be indicated as private or as public, i.e., available for collaborative use or for read/write use by others. A set or storyboard designated as private would be preferred for use as a work in progress by one user, whereas a public designation would be preferred for a collaborative use. Alternative methods of protecting various levels of access are possible.

Advantageously, the storyboard may be edited during any number of uses following the initial creation. After subsequent editing, the revised storyboard is again saved, preferably as an ordered set. The revised storyboard may be saved as a new storyboard, or may replace the prior version. Multiple storyboards can be created and then saved. In highly preferred embodiments, each storyboard is handled as the system would handle a digital asset.

The storyboard, preferably as an ordered set of videos, can be viewed, saved and/or edited. Assuming that multiple storyboards have been saved as multiple digital assets, a user can select a list of assets, display the list of assets, select an asset from that list, and bring the asset up to be displayed. In a system which recognizes digital assets, the clips that are within each storyboard, as well as the videos, could themselves be assets. Alternate ways are possible for providing a listing of the various storyboards which have been saved.

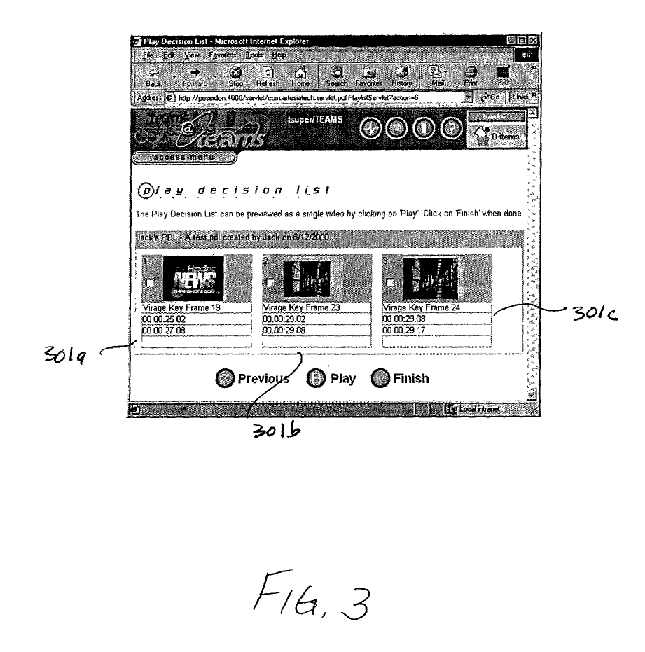

Reference is made to FIG. 3, illustrating a preview operation, where the user views a previously saved storyboard. In the preferred embodiment, the preview operation does not permit the user to edit the storyboard. When the preview operation is selected, it initially displays a list of storyboards. One of the storyboards may be selected. In the given example, the storyboards includes clips 301A, 301B, 301C. Any of the clips can be previewed, that is, played, individually or in sequence, in accordance with the preferred embodiment. A preview of a clip preferably launches a video player and runs the clip.

Each collection of clips may also be edited. That is, clips 301A, 301B, 301C may be added to or deleted from the collection. Moreover, the ordering of the items in the collection may be modified. The modified storyboard may also be saved as a derivative asset, that is, a variant of an original, or derived from a predecessor. In the preferred embodiment, editing is not done in the preview operation, so that the user must utilize the operation discussed in connection with FIG. 2 in order to perform such editing operations.

Note that “assets” as discussed in this connection may be any form of digitized asset. That is, they are not limited to video assets. Assets may include, by way of example and not limitation, animation, still shots , text and/or audio.

Further, according to highly preferred embodiments, the storyboard as a whole may be removed. The act of removing the entire storyboard simply undoes it as a set. The digital assets are still stored in the system.

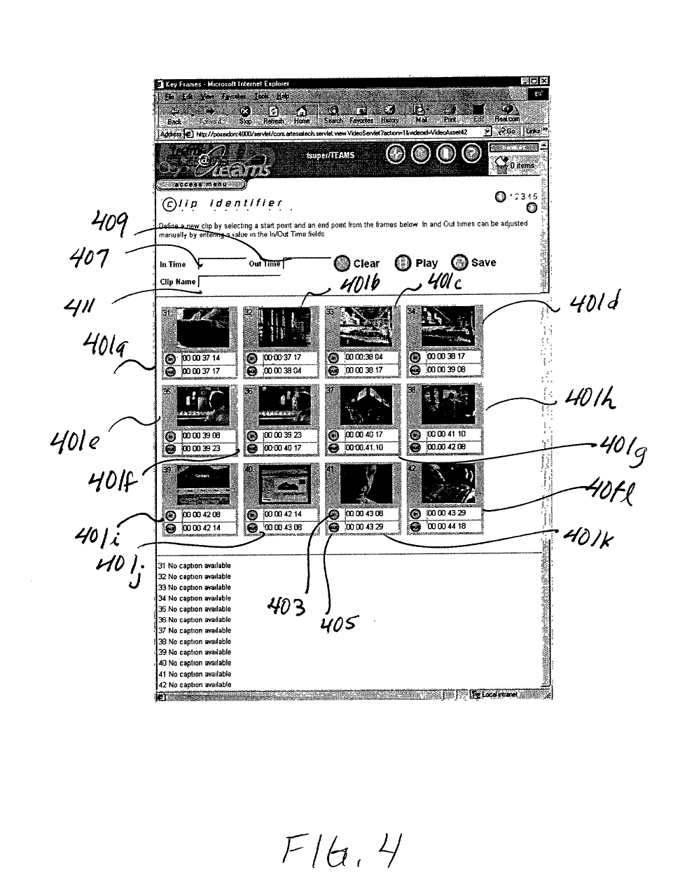

Reference is made to FIG. 4, illustrating an example of a clip identifier feature. A clip identifier is used in order to build or edit, clips. Preferably the clips to be edited have already been rough cut, as illustrated by way of example in FIG. 2. A video asset, for example a digital video or a storyboard, to be worked with is selected. Each of the key frames 401a-401l for the clips included in the video asset is displayed. A particular scene may be bracketed by selecting one or more consecutive key frames. For example, the user could select clips 401b through 401d. In the particular embodiment, an in button 403 is used to select a clip at the beginning of a bracket, and an out button 405 is used to indicate that another clip is the ending of the bracket. The bracketed set of clips is a “rough cut”. The clips could be bracketed in other ways, including by highlighting or selecting individual clips.

A user may adjust the start point and end point of the bracketed set of clips by adjusting the in time 407 and the out time 409 of the bracketed set of clips. In the given example, the key frame representing a clip is displayed together with the clip's relative start and end times. The “in” and “out” times of the bracketed set may be specified via the user interface and tweaked. Here, each clip displays its relative start and end times; the user interface provides places to specify “in” and “out” times for the bracketed clips. By use of the time adjustment in the clip identifier for selected clips in the storyboard, and by modifying the order and contents of the storyboard, the user may create and store an edited digital video clip appropriate for further use, for example in an advertisement.

The preferred embodiment also provides for associating a particular clip name 411 with the edited digital video clip, as an identifier for the bracketed set of clips. Alternative ways may be provided to identify the set. The newly defined clip, that is, the end product of the editing, may be used by the user.

In the illustrated exemplary user interface, the clip identifier feature further displays captions 414 associated with each key frame. In the particular example, there are no associated captions.

Clips may be initially populated into the system as follows: according to known techniques, a digital video is shredded into fragments and key frames for the fragments are noted, all of which are further stored in file storage. Typically, a key frame marks a change in the video, such as would be caused by angle changes, panning, and change in camera. Any close captions or other data associated with a clip and fragments of reusable video clips may be stored as well. If the video is already in a digital format, there should be no need to digitize the video, and there may be no need to shred the video. The fragments of reusable video clips, referred to herein as clips, which are created according to known technologies are utilized in the previously described features. The clips may be stored in any of various format, preferably in accordance with any appropriate digital asset management technique. Typically, the key frames are stored as well as each corresponding clip; they may be stored separately or together, although the relationship between the clip and its corresponding key frame should be noted.

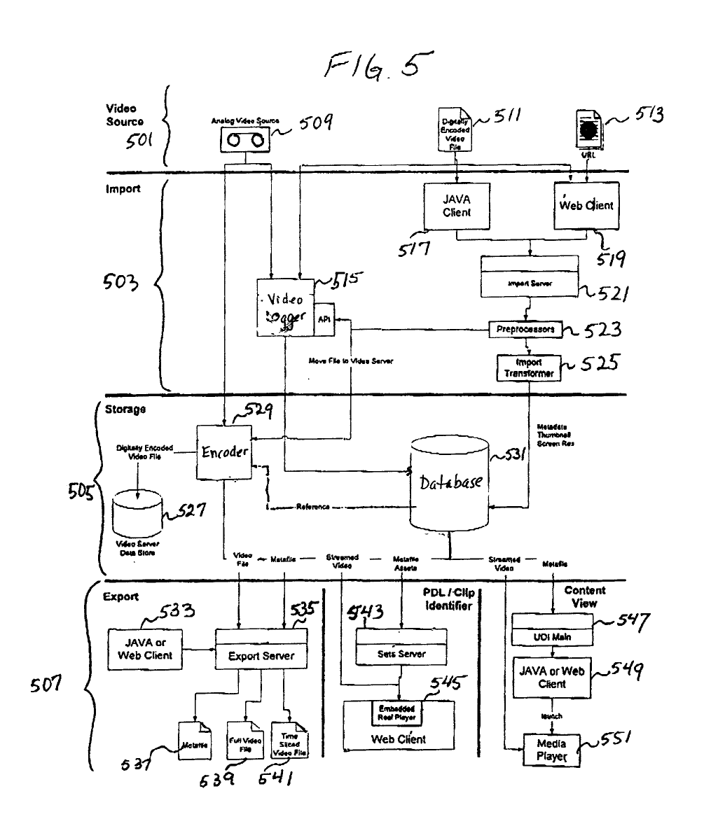

Reference is made to FIG. 5, illustrating the overall data flow of the present invention. Generally, there is provided a video source 501, an import portion 503, a storage portion 505, and an export portion 507. Video sources 501 may be provided, for example, by analog video 509, digitally encoded video file 511, and/or a URL 513.

Video data may be imported in an import stage 503. Typically, a URL 513 would be imported via a web client 519; and digitally encoded video files 511 would be imported via a JAVA client 517. Other known techniques, however, may be used to import video data. The imported video file or URL would then be typically handled by an import server 521, conventional preprocessors 523 and conventional import transformers 525. The preprocessor transmits the video data corresponding to a clip to the video logger, and transmits the key frame data corresponding to the clip to the import transformer. The import transformer optionally creates a low resolution or thumbnail version of the key frame. Data imported from an analog video source 509 would typically be digitized by conventional software 515, such as “video logger”. At the end of the import stage, the video is in digital format and has been shredded into clips and associated key frames, preferably with associated thumbnails.

Imported video would then be stored in a storage stage 505. Appropriate storage includes, for example, meta data, and/or thumb nail resolutions, stored in a data base 531; digitized video and associated key frames stored via a conventional off the shelf streaming video server encoder 529 and video server data store 527; and information tracking the correlation between a clip, its key frame, and its thumbnail (if any). A reference from the meta data and/or thumbnail resolutions in the database 531 to the corresponding clip in the encoder/video server data store in also stored. As noted above, it is convenient for the storage to handle each of these elements of data and information as a digital asset.

Any of the stored video data or thumb nails may be exported, for example to a viewer, in an export stage 507. For example, a video file or meta file could be handled through an export server 535, as provided by a JAVA or web client 533, and be further exported to a meta file 537, full video file 539 or time sliced video file 541. A request to export clips, such as streamed video and meta file assets, may be received through the above-described clip identifier; the export stage for those type of assets includes a sets server 543, and the assets are then played in a web client 545, such as through an embedded real player. In a fully realized preferred embodiment, content such as a streamed video or a meta file may be viewed through a unit of information main 547, JAVA or web client 549, or launched through a media player 551.

It should be understood that not all embodiments of the invention will include all of the foregoing functionality. For example, it may not be necessary to provide an analog video source. These and other components of the system illustrated in system in FIG. 5 may be omitted and still remain within the scope of the invention.

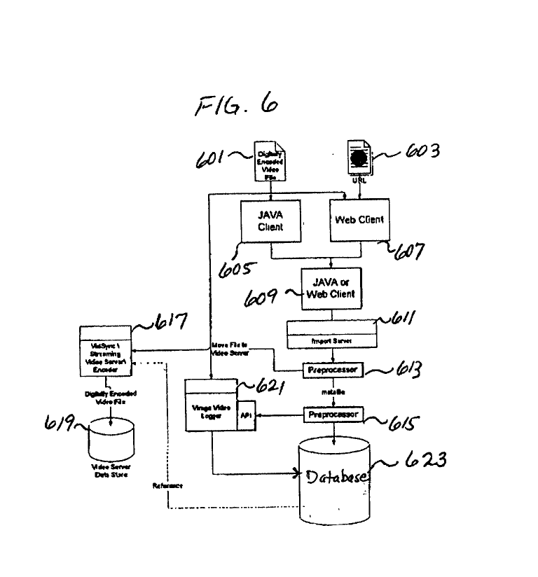

As briefly described above, video may also be exported using the invention. According to this situation, a user client communicates with the export server; then accesses a meta file, full video file or a time sliced video file. Reference is made to FIG. 6. As illustrated in FIG. 6, a digitally encoded video file 601 is imported through a JAVA client 605. Alternatively, a URL 603 is imported via a web client 607. The digital video is further input through a web client 609 and an import server 611. The preprocessor 613 then produces a meta file and transfers the digitized file to a video server 619 via the VIDSYNC/streaming video server/encoder 617. Control is then passed to a second preprocessor 615 which logs the video through conventional video logger software 621. The video is then logged to the data base 623. A reference to the logged video is itself stored. The final digital asset is a reference to the digitally encoded video on the streaming server. The “export” of a video clip is the same as downloading a clip to a user.

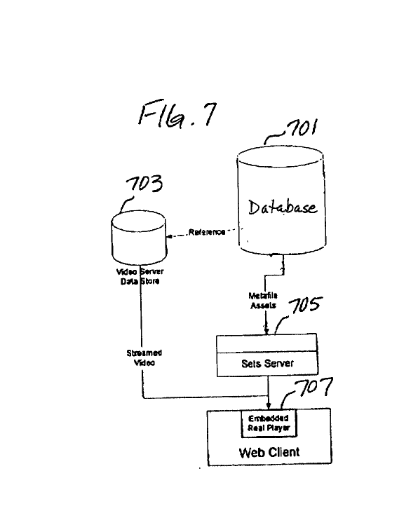

Reference is made to FIG. 7. The stored clip is accessed from the database 701. The sets server 705 retrieves an appropriate meta file from the data base 701. Additionally, the web client 707 requests the corresponding videos from the video server data store 703. Videos can be played back, for example via an embedded real player in the web client 707.

According to the invention, viewing a digital asset is analogous to playing a static asset. More specifically, viewing is the same as “seeing” a static asset. Assets are viewed through “viewsers”. Dynamic assets are viewed through applications called “players” such as music, videos and movies.

Ordinarily, viewers and players are proprietary software, due to proprietary formats of the underlying assets. Usually there is a one-to-one mapping between the file format and the player or viewer. Historically, browsers were created to de-couple the dependencies between viewable objects and viewers. Just as browsers were created to solve a problem, new applications known as “viewsers” have been created for use with playable assets, in order to de-couple the players from the assets.

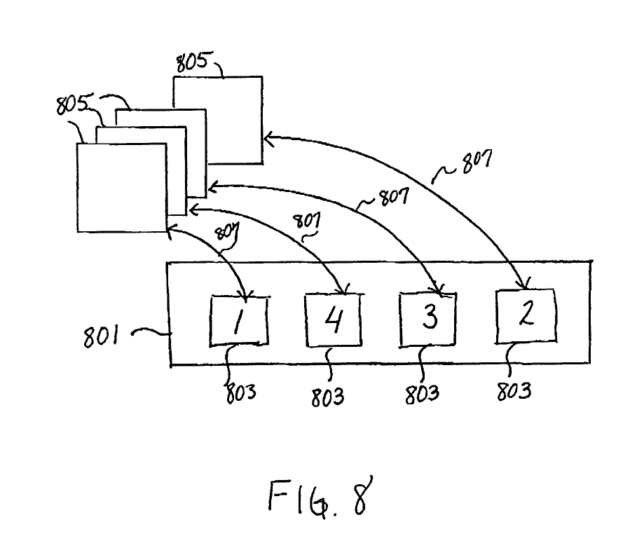

Further by way of background, in a storyboard, a key items is the sequence in which the clips occur, that is the ordered set. FIG. 8 illustrates an ordered set 801, or storyboard, of a set of clips 803. In the particular example, the thumbnails corresponding to key frames for each of the clips 803 are displayed. The thumbnails can be accessed and expanded to corresponding high resolution video assets 805. Thus, in accordance with this embodiment, the storyboard can include the easily manipulable lightweight, low resolution assets or thumb nails, which include links 807 to the high resolution assets 805. If the asset is not lightweight, optionally no link is needed to a high resolution asset. This enables the user to work on the lightweight rough cut, while the link 807 allows the user to play the high resolution video in the same sequence.

The video in its simplest sense is conventionally provided at thirty frames per second. By being able to view and point to a starting frame of each clip, a user can experience to a limited extent a full motion video corresponding to the starting frame. Therefore, a user is linking the first frame of a low resolution video to the first frame of the high resolution video. In the highly preferred embodiment, these sets are maintained as agnostic sets. “Agnostic” means that little information is needed about the file. In a highly preferred embodiment, they are stored in the current version of XML variant or implementation known as Synchronized Multimedia Integration Language, “SMIL”, version 2.0 for which the current standard is available at www.w3.org/TRsmil20.

The particular implementation of SMIL used in highly preferred embodiments is component based. The classes that instantiated the component come together at run time.

According to the storage architecture for this invention, there is no longer provided a UOI with a file reference in the central table. The central table now holds the URI. The URI is a resolvable pointer, not just a file pointer. The key point is that the pointer is “resolvable”. The URI is used to reference assets that have value. Conventionally, the URI has: [scheme, e.g., video], [authority, e.g., handler], and optionally [query], where the query is a set of name value arguments to authority.

The most highly preferred embodiment for importing clips can be described in the following algorithm:

If (assets = = video)
Then

If (digital video) ingest like a regular import process
Else (analog video)

Encode;
If (chunk?)

Then video logger
Else (ingest the clip “as is”).

It is anticipated that the most common operations for the invention will be viewing and playing of clips. Exporting of clips should be a relatively uncommon operation, since it is usually associated with the actual production of a finished clip or film. Exporting is usually an event driven request. There are typically two things to export: properties (that is the properties associated with a particular video asset), or video assets together with their properties. Exported properties would be useful, for example, in building a catalogue for rich media vending or indexing.

An export server for use with the invention should work with the meta file or a properties file, which is preferably an XML tagged file referencing time sliced video.

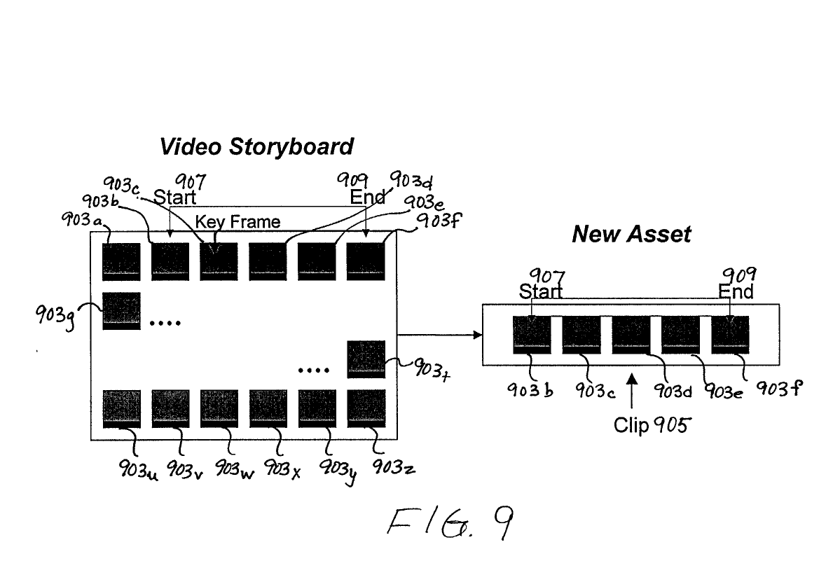

Reference is made to FIGS. 9 through 11, illustrating certain steps in creating a new video storyboard. As illustrated in FIG. 9, a video storyboard 901 displays a series of key frames 903. The key frame 903 for each clip that is part of the set of clips selected for the storyboard is displayed. The user indicates a start 907 and end 909 of a sequence of video key frames. The sequence of video clips bracketed with the indicated start and end is defined as a new asset. The new asset 905 may be stored. This particular new asset is itself termed a “clip” 905.

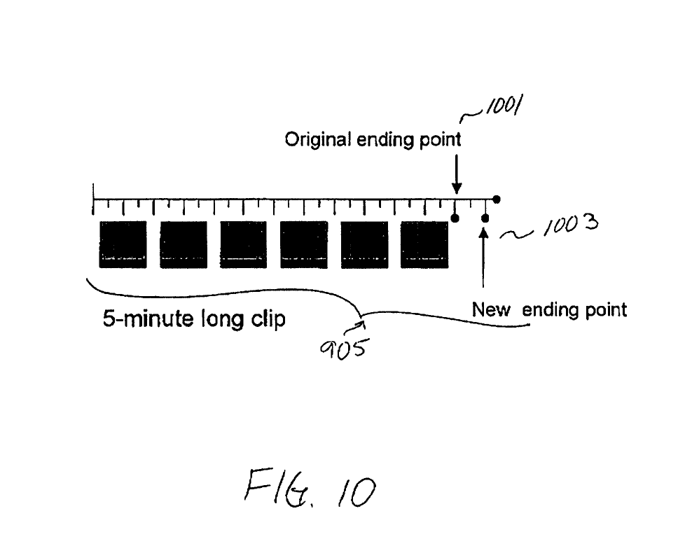

Reference is made to FIG. 10, illustrating a clip time adjuster. In this particular embodiment, the ending point of a five-minute long clip is redefined. The clip 905 includes an original ending point 1001. The user manually indicates a new ending point 1003, either by physically indicating a new ending point or indicating additional time to be added or removed to the clip. The beginning of a clip may similarly be adjusted.

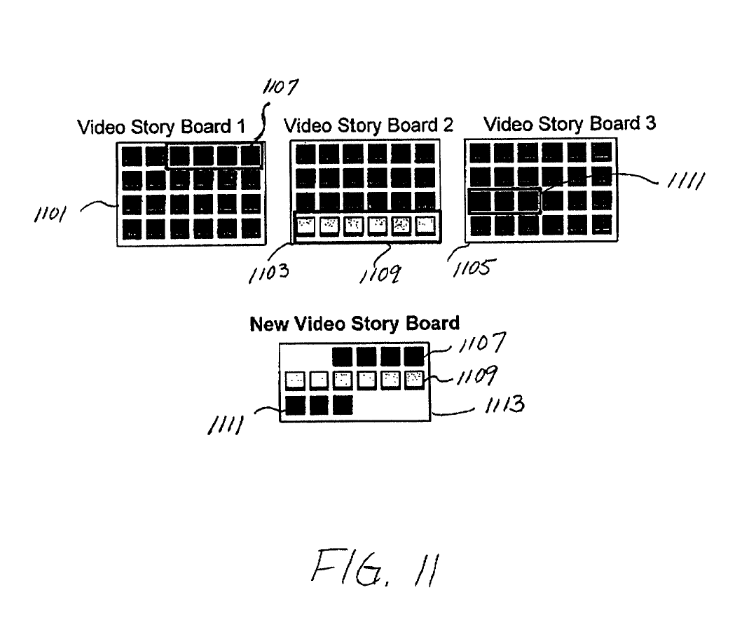

Reference is now made to FIG. 11. As illustrated, the user has selected and bracketed a clip 1107 from a first video storyboard 1101, a second clip 1109 from a second video storyboard 1103, and a third clip 1111 from a third video storyboard 1 105. The selected clips, which have been time adjusted to the user's desire, are combined into a new video storyboard 1113, including the first clip, the second clip, and third clip 1107, 1109 and 1111. The new video storyboard is stored. More particularly, according to the preferred embodiment, the set ordering of the new video storyboard is stored. As discussed above, the stored storyboard may be further edited.

Digital video may be provided in any format. Conventional examples include mpeg, etc. The use of file extensions to identify file type is well know. Foreign file types may be used, as well, if there is provided a video player that can accommodate that file type.

The invention has been described principally in connection with digital videos. Use with digital video is the most highly preferred use. Nevertheless, the invention may be used with any type of digital asset, including animation, audio, text, logos, trademarks, marketing materials, press releases, newspapers, publications of all types, broadcast advertising, internet advertising, etc.

The term “digital stream” is used herein to cover digital assets which include a temporal component. Digital audio and digital animation naturally include a temporal component. Text, for example, can include a temporal component if text is continuously displayed.

While this invention has been described in conjunction with the specific embodiments outlined above, many alternatives, modifications and variations will be apparent to those skilled in the art. Accordingly, the preferred embodiments of the invention as set forth above are intended to be illustrative, and not limiting. Various changes may be made without departing from the spirit and scope of the invention as defined in the following claims.

What is claimed is:

1. A method for computer-enabled storyboarding of digital assets, comprising the steps of:
(A) providing a storage having a plurality of digital assets, wherein at least a portion of the digital assets are digital stream, each of the digital assets including at least one digital clip, each digital clip having a plurality of frames including one key frame corresponding to the digital clip;
(B) selecting, from the plurality of digital assets, a plurality of digital clips as a storyboard;
(C) transmitting, to a computer screen, an electronic signal representing a display corresponding to the storyboard, the display presenting an image for the key frame corresponding to each of the plurality of digital clips of the storyboard; wherein the image is a low-resolution image representing the key frame for at least one digital clip of the plurality of digital clips; wherein the image further includes (i) a title associated with the at least one digital clip, (ii) and a timing of the at least one digital clip;
(D) modifying the storyboard, including (i) adding, responsive to a user add request, at least a portion of an other digital asset of the plurality of digital assets, to the plurality of digital clips as the storyboard; (ii) deleting, responsive to a user delete request, one of the plurality of digital clips from the storyboard; (iii) re-ordering, responsive to a user re-order request, an order of the digital clips in the storyboard; and (iv) storing, responsive to a user save request, the storyboard;
(E) modifying at least one of the digital clips in the storyboard, including (i) adjusting, responsive to a user request, a beginning time for at least one of the digital clips; (ii) adjusting, responsive to a user request, an end time for at least one of the digital clips; and (iii) storing, responsive to the user request, the adjusted time for at least one of the digital clips; and
(F) playing the storyboard, including playing each digital clip in the storyboard in sequence.

2. The method as claimed in claim 1, wherein the storyboard is designated as one of private access and public access.

3. The method as claimed in claim 1, wherein there are stored a plurality of storyboards, each storyboard of said plurality of storyboards comprising a different plurality of digital clips.

4. The method as claimed in claim 1, wherein, responsive to a preview request, a list of a plurality of storyboards is presented, and further responsive to a selection request, one storyboard of the plurality of storyboards is selected, and further responsive to a selection request of at least one digital clip in the storyboard, said at least one digital clip is played.

5. The method as claimed in claim 4, wherein playing the digital clip includes determining a type of the digital clip, launching a player corresponding to the type of the digital clip, and running the player for the digital clip.

6. The method as claimed in claim 1, wherein the storyboard is stored as a derivative digital asset.

7. The method as claimed in claim 1, wherein the digital assets are of a type selected from digital video, animation, still shot, text, and audio.

8. The method as claimed in claim 1, wherein the storyboard is saved in storage as an ordered set of the plurality of digital clips, representing the storyboard.

9. The method as claimed in claim 1, wherein, responsive to a request to remove a selected one of the storyboards, the ordered set representing the selected one of the storyboards is deleted.

10. The method as claimed in claim 1, further comprising the step of associating a clip name with the storyboard.

11. The method as claimed in claim 1, further comprising the step of storing a caption for the key frame for at least one of the digital clips, wherein the display corresponding to the storyboard includes said caption for the key frame.

12. The method as claimed in claim 1, further comprising the step of storing each of said digital clips, each of said corresponding key frames, and data concerning a correspondence between said digital clip and said corresponding key frame.

13. The method as claimed in claim 12, further comprising, for at least one of said digital clips, a lightweight image for the corresponding key frame for the at least one digital clip, further comprising the step of storing the lightweight image.

14. The method as claimed in claim 13, wherein storage for the lightweight image is a database; and wherein storage for the digital clips and the key frames includes a streaming video server data store.

15. The method as claimed in claim 1, further comprising the step of exporting the plurality of digital clips in the storyboard in an export stage.

16. The method as claimed in claim 1, further comprising the step of importing at least one of the digital assets.

17. The method as claimed in claim 16, wherein the importing step includes importing a digitally encoded video file as at least one of the digital assets.

18. The method as claimed in claim 16, wherein the importing step includes importing a resource located at a URL as at least one of the digital assets.

19. The method as claimed in claim 14, further comprising the step of accessing at least one of the selected digital clips from the database, including retrieving a corresponding meta file from the database, and retrieving a corresponding digital stream from the streaming video server data store.

20. The method as claimed in claim 16, wherein the step of importing at least one of the digital assets includes:
(i) if the at least one digital asset is analogous to video, and if the at least one digital asset is digital video, then ingesting the at least one digital asset via a regular import;
(ii) otherwise, if the at least one digital asset is analogous to video and if the at least one digital asset is analog video, then encoding the at least one digital asset; and if a chunk is requested, then (a) inputting the at least one digital asset to a video logger to create a plurality of digital clips; otherwise (b) utilizing the at least one digital asset as one of the plurality of digital clips.

21. The method as claimed in claim 1, wherein a plurality of properties are associated with at least a portion of the plurality of digital assets, and further comprising the step of exporting the plurality of properties associated with at least one digital asset of the plurality of digital assets.

22. The method as claimed in claim 1, wherein a plurality of properties are associated with at least a portion of the plurality of digital assets, and further comprising the step of exporting (i) at least one digital asset of the plurality of assets, and (ii) the plurality of properties associated with the at least one digital asset.

23. A system for computer-enabled storyboarding of digital assets, comprising:
(A) an electronic storage having stored therein a plurality of digital assets, wherein at least a portion of the digital assets are digital stream, each of the digital assets including at least one digital clip, each digital clip having a plurality of frames including one key frame corresponding to the digital clip;
(B) a plurality of digital clips, selected from the plurality of digital assets, as a storyboard;
(C) an electronic signal representing a display corresponding to the storyboard, the display presenting an image for the key frame corresponding to each of the plurality of digital clips of the storyboard; wherein the image is a low-resolution image representing the key frame for at least one digital clip of the plurality of digital clips; wherein the image further includes (i) a title associated with the at least one digital clip, (ii) and a timing of the at least one digital clip;
(D) a library of commands to modify the storyboard, including (i) a user add request, to add at least a portion of an other digital asset of the plurality of digital assets, to the plurality of digital clips as the storyboard; (ii) a user delete request, to delete one of the plurality of digital clips from the storyboard; (iii) a user re-order request, to re-order an order of the digital clips in the storyboard; and (iv) a user save request, storing the storyboard;
(E) a library of commands to modify at least one of the digital clips in the storyboard, including (i) a first user adjust request, to adjust a beginning time for at least one of the digital clips; (ii) a second user adjust request, to adjust an end time for at least one of the digital clips; and (iii) a user store request, to store the adjusted time for at least one of the digital clips; and
(F) a player, to play each digital clip in the storyboard in sequence.

24. The system as claimed in claim 23, wherein the storyboard is designated as one of private access and public access.

25. The system as claimed in claim 23, wherein there are stored a plurality of storyboards, each storyboard of said plurality of storyboards comprising a different plurality of digital clips.

26. The system as claimed in claim 23, further comprising a preview request and a selection request, wherein, responsive to a preview request, a list of a plurality of storyboards is presented, and further responsive to a selection request, one storyboard of the plurality of storyboards is selected, and further responsive to a selection request of at least one digital clip in the storyboard, said at least one digital clip is played by the player.

27. The system as claimed in claim 26, wherein the player determines, for the digital clip to be played, a type of the digital clip, launches a player corresponding to the type of the digital clip, and runs the player for the digital clip.

28. The system as claimed in claim 23, wherein the storyboard is stored as a derivative digital asset.

29. The system as claimed in claim 23, wherein the digital stream are of a type selected from digital video, animation, still shot, text, and audio.

30. The system as claimed in claim 23, wherein the storyboard is saved in storage as an ordered set of the plurality of digital clips, representing the storyboard.

31. The system as claimed in claim 23, further comprising a remove request, wherein, responsive to a request to remove a selected one of the storyboards, the ordered set representing the selected one of the storyboards is deleted from storage.

32. The system as claimed in claim 23, further a clip name associated with the storyboard.

33. The system as claimed in claim 23, further comprising a caption stored for the key frame for at least one of the digital clips, wherein the display corresponding to the storyboard includes said caption for the key frame.

34. The system as claimed in claim 23, further comprising data, stored in the electronic storage, concerning a correspondence between said digital clip and said corresponding key frame.

35. The system as claimed in claim 34, further comprising, for at least one of said digital clips, a lightweight image for the corresponding key frame for the at least one digital clip, wherein the lightweight image is stored in the electronic storage.

36. The system as claimed in claim 35, wherein the electronic storage having the lightweight image is a database; and wherein the electronic storage having the digital clips and the key frames includes a streaming video server data store.

37. The system as claimed in claim 23, further comprising an export stage, wherein the plurality of digital clips in the storyboard are exported from the electronic storage.

38. The system as claimed in claim 23, further comprising an import stage, wherein at least one of the digital assets are imported.

39. The system as claimed in claim 38, wherein the import stage has imported a digitally encoded video file imported as at least one of the digital assets.

40. The system as claimed in claim 38, wherein the import stage has imported a resource located at a URL imported as at least one of the digital assets.

41. The system as claimed in claim 36, wherein an accessed one of the selected digital clips in the database, includes a corresponding meta file in the database, and a corresponding video in the streaming video server data store.

42. The system as claimed in claim 38, wherein the import stage includes:
(i) if the at least one digital asset is analogous to video, and if the at least one digital asset is digital video, then the at least one digital asset ingested via a regular import;
(ii) otherwise, if the at least one digital asset is analogous to video and if the at least one digital asset is analog video, then the at least one digital asset is encoded; and if a chunk is requested, then (a) the at least one digital asset is input to a video logger to create a plurality of digital clips; otherwise (b) the at least one digital asset is utilized as one of the plurality of digital clips.

43. The system as claimed in claim 23, wherein a plurality of properties are associated with at least a portion of the plurality of digital assets, and the plurality of properties associated with at least one digital asset of the plurality of digital assets are exported.

44. The system as claimed in claim 23, wherein a plurality of properties are associated with at least a portion of the plurality of digital assets, and wherein (i) at least one digital asset of the plurality of assets and (ii) the plurality of properties associated with the at least one digital asset, are exported.

45. A system for computer-enabled storyboarding of digital assets, comprising:
(A) means for providing a storage having a plurality of digital assets, wherein at least a portion of the digital assets are digital stream, each of the digital assets including at least one digital clip, each digital clip having a plurality of frames including one key frame corresponding to the digital clip;
(B) means for selecting, from the plurality of digital assets, a plurality of digital clips as a storyboard;
(C) means for transmitting, to a computer screen, an electronic signal representing a display corresponding to the storyboard, the display presenting an image for the key frame corresponding to each of the plurality of digital clips of the storyboard; wherein the image is a low-resolution image representing the key frame for at least one digital clip of the plurality of digital clips; wherein the image further includes (i) a title associated with the at least one digital clip, (ii) and a timing of the at least one digital clip;
(D) means for modifying the storyboard, including (i) adding, responsive to a user add request, at least a portion of an other digital asset of the plurality of digital assets, to the plurality of digital clips as the storyboard; (ii) deleting, responsive to a user delete request, one of the plurality of digital clips from the storyboard; (iii) re-ordering, responsive to a user re-order request, an order of the digital clips in the storyboard; and (iv) storing, responsive to a user save request, the storyboard;
(E) means for modifying at least one of the digital clips in the storyboard, including
(i) adjusting, responsive to a user request, a beginning time for at least one of the digital clips;
(ii) adjusting, responsive to a user request, an end time for at least one of the digital clips; and
(iii) storing, responsive to the user request, the adjusted time for at least one of the digital clips; and
(F) means for playing the storyboard, including playing each digital clip in the storyboard in sequence.

46. The system as claimed in claim 45, wherein the storyboard is designated as one of private access and public access.

47. The system as claimed in claim 45, wherein there are stored a plurality of storyboards, each storyboard of said plurality of storyboards comprising a different plurality of digital clips.

48. The system as claimed in claim 45, wherein, responsive to a preview request, a list of a plurality of storyboards is presented, and further responsive to a selection request, one storyboard of the plurality of storyboards is selected, and further responsive to a selection request of at least one digital clip in the storyboard, said at least one digital clip is played.

49. The system as claimed in claim 48, wherein the means for playing the digital clip includes means for determining a type of the digital clip, means for launching a player corresponding to the type of the digital clip, and means for running the player for the digital clip.

50. The system as claimed in claim 45, wherein the storyboard is stored as a derivative digital asset.

51. The system as claimed in claim 45, wherein the digital stream are of a type selected from digital video, animation, still shot, text, and audio.

52. The system as claimed in claim 45, wherein the storyboard is saved in storage as an ordered set of the plurality of digital clips, representing the storyboard.

53. The system as claimed in claim 45, wherein, responsive to a request to remove a selected one of the storyboards, the ordered set representing the selected one of the storyboards is deleted.

54. The system as claimed in claim 45, further comprising means for associating a clip name with the storyboard.

55. The system as claimed in claim 45, further comprising means for storing a caption for the key frame for at least one of the digital clips, wherein the display corresponding to the storyboard includes said caption for the key frame.

56. The system as claimed in claim 45, further comprising means for storing each of said digital clips, each of said corresponding key frames, and data concerning a correspondence between said digital clip and said corresponding key frame.

57. The system as claimed in claim 56, further comprising, for at least one of said digital clips, a lightweight image for the corresponding key frame for the at least one digital clip, further comprising means for storing the lightweight image in storage.

58. The system as claimed in claim 57, wherein storage for the lightweight image is a database; and wherein storage for the digital clips and the key frames includes a streaming video server data store.

59. The system as claimed in claim 45, further comprising means for exporting the plurality of digital clips in the storyboard in an export stage.

60. The system as claimed in claim 45, further comprising means for importing at least one of the digital assets.

61. The system as claimed in claim 60, wherein the importing means includes means for importing a digitally encoded video file as at least one of the digital assets.

62. The system as claimed in claim 60, wherein the importing means includes means for importing a resource located at a URL as at least one of the digital assets.

63. The system as claimed in claim 60, further comprising means for accessing at least one of the selected digital clips from the database, including means for retrieving a corresponding meta file from the database, and means for retrieving a corresponding video from the streaming video server data store.

64. The system as claimed in claim 60, wherein the importing means for at least one of the digital assets includes:
(i) if the at least one digital asset is analogous to video, and if the at least one digital asset is digital video, then means for ingesting the at least one digital asset via a regular import;
(ii) otherwise, if the at least one digital asset is analogous to video and if the at least one digital asset is analog video, then means for encoding the at least one digital asset; and if a chunk is requested, then (a) means for inputting the at least one digital asset to a video logger to create a plurality of digital clips; otherwise (b) means for utilizing the at least one digital asset as one of the plurality of digital clips.

65. The system as claimed in claim 45, wherein a plurality of properties are associated with at least a portion of the plurality of digital assets, and further comprising means for exporting the plurality of properties associated with at least one digital asset of the plurality of digital assets.

66. The system as claimed in claim 45, wherein a plurality of properties are associated with at least a portion of the plurality of digital assets, and further comprising means for exporting (i) at least one digital asset of the plurality of assets, and (ii) the plurality of properties associated with the at least one digital asset.
